(19) United States
(12) Patent Application Publication
(10) Pub. No.: US 2020/0256359 A1
(43) Pub. Date: Aug. 13, 2020

(54) Flow Restrictor and Process for Fabricating the same

(71) Applicant: Guanghua WU, McKinney, TX (US)

(72) Inventor: Guanghua WU, McKinney, TX (US)

(21) Appl. No.: 16/501,465

(22) Filed: Feb. 12, 2019

(51) Int. Cl. F15D 1/02

(52) U.S. Cl. CPC F15D 1/025

(57) ABSTRACT

A wound foil restrictor is fabricated by winding isolating foil and flow foil on a mandrel. The flow foil is made by etching multiple through flow channels for one or more restrictors; in the latter case, the restrictors will be wound at once and cut into several restrictors by laser, plasma or water jet.

### FIELD OF THE INVENTION

The present invention is related to flow restrictors used by mass flowmeters and mass flow controllers.

### BACKGROUND OF THE INVENTION

Flow restrictor, also being called bypass, splitter, is a laminar flow element (LFE). It will regulate the flow and make it laminar. It is the linear characteristic between the flow velocity and the pressure drop across the LFE, inherent for laminar flow, that is demanded by many flow apparatuses. For a true laminar flow circular pipe, the Hagen-Poiseuille equation can be applied:

$$Δ p = \frac{32 μ v L}{2 D g} ,$$

where Δp is the pressure drop between two ends; μ is the dynamic viscosity of the fluid; v is the mean velocity in the pipe; L is the length of the pipe; D is the diameter of the pipe and g is the gravitational acceleration. By comparison, in turbulence flow, the Darcy equation can be used:

$$Δ p = \frac{f L {v}^{2}}{2 D g} ,$$

where f is a friction coefficient depending on the mean velocity. It is a quadratic relationship between the flow velocity and the pressure drop. As mass flow rate is directly related to the velocity by: \dot{m}=ρAv, where m is the mass flow rate; and A is the section area of the pipe, so for a true laminar flow, the relationship between the pressure drop and the flow rate is linear.

Reynolds number, Re, a dimensionless number, is used to judge whether a flow is laminar or turbulent:

$${R}_{e} = \frac{{D}_{h} v ρ}{μ} ,$$

where Dₕ is hydraulic diameter, it is defined as

$${D}_{h} = \frac{4 A}{s} ,$$

where A is flow area and s is wetted perimeter. In pipeline flow, when the Reynolds number is less than (approximately) 2100, the flow is said to be laminar, when the Reynolds number is greater than (approximately) 4000, the flow is said to be turbulent, and when Reynolds number is between 2100 and 4000, the flow is said to be in a critical zone or transition region. It should be understood that even in the laminar region, the relationship between the pressure drop and the flow rate is generally not true linear, and how linear it is will depend on the magnitude of Reynolds number. For example, for pipeline flow, when Reynolds number is less than 100, compare with a straight line, the nonlinearity can be as large as 0.5%, for Reynolds number less than 200, the nonlinearity can be as large as 1%, and when Reynolds number is around 500, the nonlinearity can be as large as 5%. Although these nonlinearities can be calibrated in the applications, but errors are inevitable. Poor linearity will also increase the errors when working gases are different with the calibrating gas and working flow rate ranges are different with the calibrating flow rate range. Due to the size limitation of flowmeters and flow controllers, it is relatively easier to design a restrictor with a low Re number when the flow rate is low, but with the increasing of the flow rates, it is getting harder to do so.

Tube restrictors (U.S. Pat. Nos. 3,487,688, 6,826,953 and 7,107,834) works well in low flow rates (have low Reynolds number), but at high flow rates, to increase flow rate and keep required pressure drop (required pressure drop is most likely decided by the pressure drop produced by the minimum flow rate in sensor tube for thermal based flowmeters or the resolution requirement for pressure based flowmeters), the inner diameters of the tubes need to be bigger and the number of the tubes needs to be larger, the former increases the Reynolds number and the latter increases the cost, both in materials (sometime more than 1000 tubes are needed) and in machining.

Annular gap (plug) restrictors (U.S. Pat. Nos. 4,522,058, 4,524,616, 4,571,801, 4,576,204, 5,099,881, 5,445,035, 6,119,730 and 6,247,495) are similar to tube restrictors characteristically, having difficulties in high flow rates. To increase the flow rate, the size of the annular gap needs to be increased, the consequence is the increasing of Reynolds number and deterioration of flow linearity. To solve the problem, slots are made on the restrictors (U.S. Pat. No. 4,800,754 and U.S. Patent Application Publication No. US20050241412), but the slots need to be machined by Electrical Discharge Machining (EDM), and the cost is high.

Etched disk restrictors (U.S. Pat. Nos. 3,851,526, 4,427,030, 4,450,718, 4,497,202, 5,511,416, 5,576,498, 5,672,821, 6,886,401, 7,431,045 and 8,376,312) can be used both in low flow rates and high flow rates with low Reynolds numbers, but the flow direction may pose difficult for the design of the flowmeters, and the part number and manufacture cost are generally higher than that of this invention.

Foil wound restrictors (U.S. Pat. Nos. 3,071,160, 3,123,900, 3,349,619, 3,981,689, 4,886,711, US20020006523, CN2569107, WO2004106752 and KR20110080060) may be the best suitable for high flow rates. In WO2004106752, a single foil, with etched slots on it, wound on a pin to form multiple flow paths. The disadvantage is that the dimensions of the etched slots need to be carefully controlled, but the etching depths of the slots are not so easy to control. Failed to do so will reduce the uniformity of the restrictors. Most of other foil wound restrictors are using two layers of foils, one is plain foil, served as isolator and another one is corrugated to form the flow channels. The disadvantage of this kind of restrictors is that the corrugated layer of foil is not very rigid in shape, it is hard to handle during winding. It will be deformed wherever being pressed and makes the flow passages not uniform.

One of the objects of the present invention is to provide a restrictor design with good linearity at high flow rate.

Another object of the present invention is to provide a restrictor design with stable structure and uniformity.

Another object of the present invention is to provide a fabricating process of restrictors which is relatively simple, efficient and inexpensive.

### SUMMARY OF THE INVENTION

In this invention, two layers of foils, one is a plain foil, another one is an etched foil which has etched pattern for one or multiple flow passages of one or more restrictors, are paired together, spirally wrapped on a mandrel. The pattern on the etched foil will form flow channels for one or more restrictors. After winding, the formed bar will be cut by a laser or plasma or water jet cutter to get one or more restrictors.

### BRIEF DESCRIPTION OF THE DRAWINGS

FIG. 1A is a view of a flow foil of this invention and FIG. 1B is the detail view A of FIG. 1A.

FIG. 2 is a perspective view while the flow foil just being spot-welded to the mandrel.

FIG. 3 is a perspective view of both flow foil and isolating foil have been spot-welded to the mandrel.

FIG. 4 is a perspective view of the restrictor bar after winding has been finished.

FIG. 5 is a sketch showing where the restrictor bar will be cut to form individual restrictors.

FIG. 6A is a perspective view of the finished restrictor and FIG. 6B is its end view.

FIG. 7 is a section view of the restrictor with an outside sleeve.

### DETAILED DESCRIPTION OF THE INVENTION

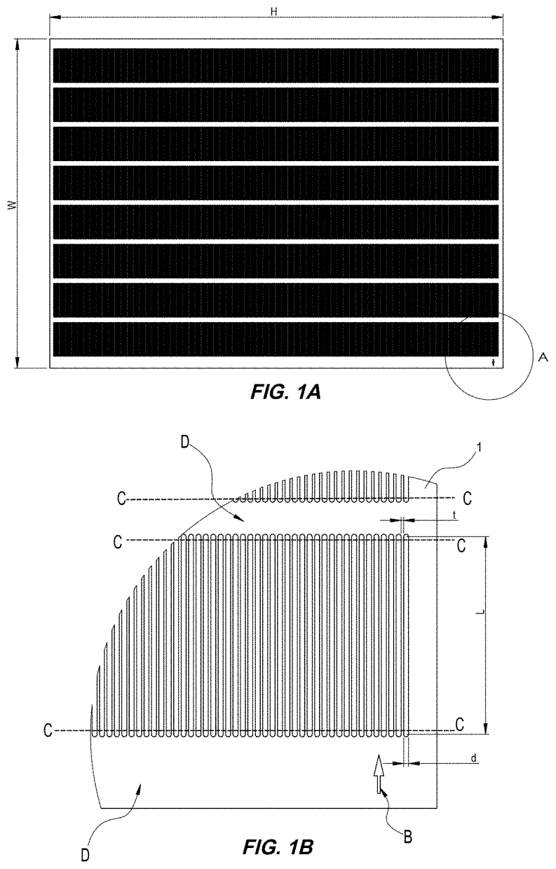

Foil wound restrictors of this invention consist of flow foil, isolating foil and mandrel as the basic elements. FIG. 1A is a view of the flow foil 1 and FIG. 1B is a detail view A of the flow foil 1. All the materials for the components in this invention should be compatible to fluid(s) that may come in contact with the components, and exemplary materials is 316L stainless steel. For the handling easiness, the material status of flow foil 1 prefers to be full hardened or half hardened. The thickness of the foil is 0.002″ to 0.005″, as the slots on the foil will be etched through, this will be the depth of the flow passageways on the final restrictors. The width of the foil W will depend on the source of the foil and the length of the foil H will depend on the mandrel diameter and the outer diameter of the finished restrictors. This dimension can be decided experimentally. Referring to FIG. 1B, the arrow B shows the flow direction. The width of each slot d is around 0.005″ to 0.10″ and the length L of the slots will depend on how long the finished restrictors are. The distance t between the edges of two adjacent slots is around 0.002″ to 0.010″. To increase the porosity of the final restrictors so as to increase the flow rate per area of the section of the restrictors, this dimension prefers to be as small as possible but should be wide enough to have enough strength to hold the foil together for handling. For ordinary restrictors used in thermal sensor flowmeters, the proposed slot dimensions herein are corresponding to Re numbers less than 30 and the nonlinearity is going to be less than 0.3%. For the pattern shown in FIG. 1A, eight restrictors will be made at once. In FIG. 1B, the dotted lines C-C show where they are going to be cut after finishing winding. The distance between C-C lines will be the length of finished restrictors. The areas D will be discarded by cutting and the flow passageways of finished restrictors will be unblocked. The flow foil can also be a narrow tape with only one restrictor to be made at a time. It can be imaged that it is inefficient both in the utilization of the material and productivity of fabricating. The etched foil tape will also be too weak to hold itself together.

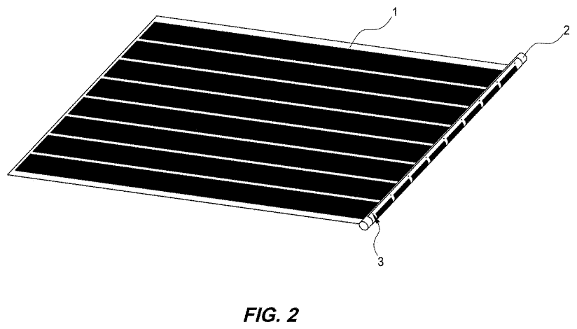

FIG. 2 shows the stage when the flow foil has just been spot-welded to the mandrel 2, a round bar. The diameter of the mandrel can be big enough to attach the foils and small enough to wind one layer of flow foil and one layer of isolating foil. It is also a parameter to adjust for flow rates. When the outer diameter of finished restrictors is fixed, thinner diameter of the mandrel will flow more fluid at the same pressure drop. The length of mandrel 2 can be longer than the width of flow foil 1 W, leave two ends to be clamped by winding mechanism. Before winding, the flow foil 1 will be spot-welded to the mandrel 2 at locations 3. The locations of spot-welding 3 are at the locations between restrictor patterns so the winding force can be better taken by the un-etched areas of the foil.

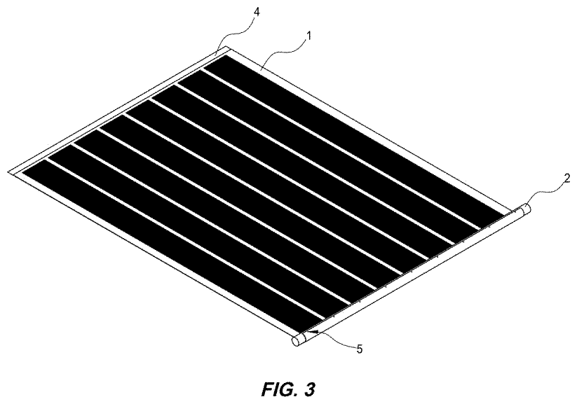

As shown in FIG. 3, isolating foil 4 will then be superimposed to the flow foil 1 and spot-welded at 5. Isolating foil 4 is a plain metal foil, also hardened with a thickness around 0.001″. The width of the isolating foil 4 is the same as flow foil 1. The length of the isolating foil 4 will be longer than the flow foil 1 so after finishing wrapping, the isolation foil 4 will cover the whole flow foil 1. The total length of the isolating foil for each restrictor is depended on the diameter of the mandrel and outer diameter of finished restrictor. As mentioned for flow foil 1, it can be decided by experiments with fair accuracy. As there is no pattern on the isolating foil, it can be cut at any location, so it can be used as a remedy to compensate the winding deviation, make the outer diameter of wound restrictor bar meet the diameter tolerance requirement.

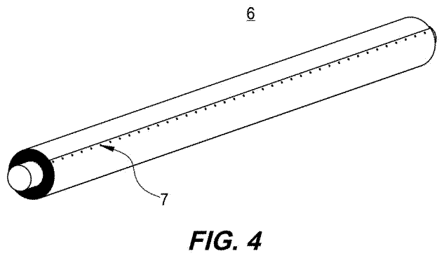

During winding, spot-welds can be applied from time to time, especially if the finished restrictors have large outer diameters and the diameters of mandrels are relatively small. By maintaining a uniform tightness of winding, the tolerance of mandrel 4, flow foil 1 and isolating foil 2, with experimentally decided foil lengths, the finished restrictors shall have consistent outer diameters and the flow resistances shall also be consistent. FIG. 4 shows a finished restrictor bar 6 wherein 7 are spot-welds.

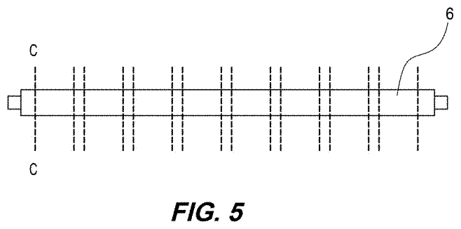

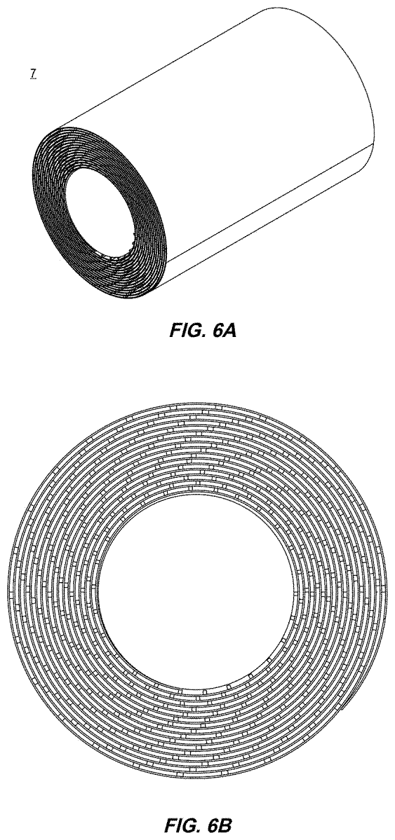

The dotted lines C-C in FIG. 5 show where the restrictor bar 6 will be cut by either laser, plasma or water jet cutter. The locations are decided by the pattern, the same as the cutting lines C-C shown in FIG. 1B. Grounding can be used to improve the surface finish of the cutting ends. FIG. 6A is a perspective view of a finished restrictor 7 and FIG. 6B is its end view.

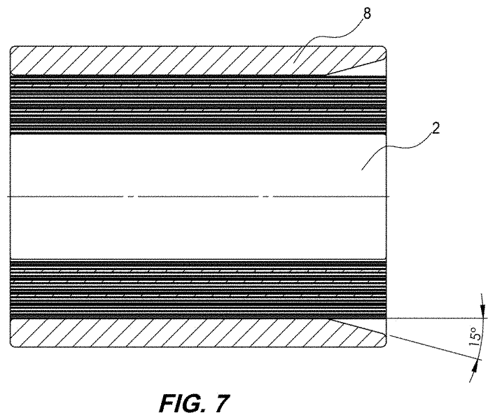

The finished restrictors can be pushed into a sleeve 8 as shown in FIG. 7. If the inner diameter of sleeve 8 is around 0.001″ smaller than the outer diameter of restrictor 6, with an induction angle around 15′, the restrictor can be pressed into the sleeve 8 easily and stay there firmly to stand impacts occurring during shipment and handling. The finished restrictors can also be used without sleeves by pressing into the bore of flowmeters or other flow apparatus. In both cases, to do a metallic heat fusion will be helpful to stabilize the parts. In heat fusion, the parts will be heated in a furnace, preferably one with a hydrogen atmosphere, to the eutectic point of at least one of the component materials then cooled down. Although many dimensions have been given in this invention, but the actual dimensions will depend on the requirements of linearity, flow rate, pressure drop, and other factors.

What is claimed is:

1. A flow restrictor comprising as the basic elements thereof:
a flat foil; an etched foil, and a mandrel.

2. The flow restrictor of claim 1, wherein said etched foil is a metal foil with one or more through elongated slots.

3. The etched foil of claim 2, wherein the pattern of said elongated slots have one or more rows to make one or more restrictors at once.

4. A process of making said flow restrictor of claim 1, comprising pairing said flat foil and said etched foil together, and wound them on said mandrel to form a bar, so that said etched foil is sandwiched between flat foils, whereby the longer direction of said elongated slots is parallel with the axis of said flow restrictor and form flow passageway(s) with flat foils and side walls of said elongated slots.

5. A process of making said flow restrictor of claim 4, said bar will be cut into one or more restrictors of claim 1, said flow passageway(s) will become unblocked.
